(19) United States
(12) Patent Application Publication
(10) Pub. No.: US 2025/0329260 A1
(43) Pub. Date: Oct. 23, 2025

(54) MOVING OBJECT OPERATION MANAGEMENT DEVICE

(71) Applicant: HITACHI, LTD., Tokyo (JP)

(72) Inventors: Mikio BANDO, Tokyo (JP); Takahiro ITO, Tokyo (JP); Mitsuru MATSUBARA, Tokyo (JP); Taku SHIMIZU, Tokyo (JP)

(21) Appl. No.: 18/873,052

(22) PCT Filed: May 12, 2023
(86) PCT No.: PCT/JP2023/017995

§ 371 Date: Dec. 9, 2024

(30) Foreign Application Priority Data
Jul. 20, 2022 (JP) 2022-115432

(51) Int. Cl. G08G 5/32; B64U 101/64; G08G 5/52; G08G 5/57

(52) U.S. Cl. CPC G08G 5/32; G08G 5/52; G08G 5/57; B64U 2101/64

(57) ABSTRACT

A moving body operation management device makes safe and efficient take-off and landing possible when a plurality of drones are approaching one take-off and landing port. Moving bodies are loaded with a conveyance target which is an article or a person, and move from a departure location to an arrival location in accordance with an instructed route. A movement time prediction calculation unit calculates the movement times of the moving bodies; and an occupation probability calculation unit calculates the probability that a take-off and landing port which the moving bodies take off from and land at will be occupied by the moving bodies on the basis of movement time uncertainty, which is calculated using information that affects the operation of the moving bodies. A usage plan is optimized by an optimization unit so that the take-off and landing port will be occupied by the moving bodies at all times.

### TECHNICAL FIELD

The present invention relates to a moving object operation management device that uses a flying object to perform movement and transport, and particularly to a moving object operation management device that uses a vertical take-off and landing aircraft (VTOL) that can take off and land vertically as a flying object.

### BACKGROUND ART

Recently, a system has been proposed, which uses an unmanned flying object called a drone that takes off and lands in a vertical direction with respect to a landing surface to transport a package to a destination. As this drone, a multi-rotor type drone having a plurality of blade rotors is generally used.

A transport system for this drone receives data representing a planned horizontal flight route of the drone. Then, the system acquires height reference values representing the elevation of a surface below each of multiple positions on the planned flight route, and uses a value obtained by adding flight altitudes corresponding to the positions to the height reference values as altitude data for the planned flight route.

This allows the drone to fly along the planned flight route without colliding with obstacles.

In such a transport system using drones, it is important that a large number of drones can efficiently arrive and land at destinations. Therefore, for a landing control device for a drone, for example, a method described in Patent Literature 1 has been proposed.

This Patent Literature 1 discloses a flight management system that manages reservations for take-off and landing ports where a drone that can autonomously fly take off and land, and manages flight plans and flight positions of multiple drones that autonomously fly between the take-off and landing ports. When multiple drones jointly use take-off and landing ports, management of reservations for the take-off and landing ports allows multiple drones to approach a single take-off and landing port.

To manage reservations for the take-off and landing ports, it is necessary to improve efficiency by taking into consideration factors such as when a drone will land and take off, and whether or not there will be time for power supply and maintenance of the drone.

Patent Literature 2 discloses, for a drone provided with a battery, a method of acquiring flying object information and location information, presenting the shortest time required for reaching a power supply facility, an average flight period, and a power supply start time and a wait time that are obtained in consideration of avoidance of an area with bad weather and the like, and efficiently enabling power supply.

### CITATION LIST

### Patent Literature

Patent Literature 1: WO 2018/155700

Patent Literature 2: WO 2021/245836

### SUMMARY OF INVENTION

### Technical Problem

By the way, the methods described in Patent Literature 1 and Patent Literature 2 do not take into consideration the fact that multiple drones take off and land at a take-off and landing port, and thus in a case where a reservation is to be made, it is necessary to make a reservation so that a take-off and landing port used by each drone is not overlappingly used by another drone.

However, considering that each drone may arrive at take-off and landing ports earlier or later than a scheduled time depending on circumstances at the time of the take-off and landing and route conditions, it is necessary to make redundant reservations with plenty of time before and after the original occupancy time.

In a case where this reservation method is used at a single take-off and landing port where multiple drones approach, the efficiency of using the port decreases when all the drones operate on schedule. In addition, even if there is a time zone when a port is available, the port is not available for use by unreserved drones, which will reduce the efficiency of a system as a whole.

In view of such problems, an object of the present invention is to provide a moving object operation management device and a moving object operation management method that enable a plurality of drones to take off and land safely and efficiently in a case where the drones approach a single take-off and landing port.

### Solution to Problem

The present invention is configured as follows in order to achieve the above-described object.

A moving object operation management device that manages operation of a plurality of moving objects that carry an object to be transported, such as an article or a person, and move along a specified route from a location of departure to a location of arrival includes: a movement time prediction and calculation unit that calculates movement times of the moving objects; an occupancy probability calculation unit that calculates, based on uncertainty in the movement times calculated based on information that affects the operation of each of the plurality of moving objects, a probability that the plurality of moving objects occupy a take-off and landing port where the moving objects take off and land; and a usage plan optimization unit that makes a plan such that the take-off and landing port is occupied by the plurality of moving objects at all times.

A moving object operation management method for a moving object operation management device that manages operation of a plurality of moving objects that carry an object to be transported, such as an article or a person, and move along a specified route from a location of departure to a location of arrival includes: calculating movement times of the moving objects; calculating, based on uncertainty in the movement times calculated based on information that affects the operation of each of the plurality of moving objects, a probability that the plurality of moving objects occupy a take-off and landing port where the moving objects take off and land; and making a plan such that the take-off and landing port is occupied by the moving objects at all times.

### Advantageous Effects of Invention

According to the present invention, it is possible to provide a moving object operation management device and a moving object management method that enable a plurality of drones to take off and land safely and efficiently in a case where the plurality of drones approach a single take- off and landing port.

### BRIEF DESCRIPTION OF DRAWINGS

FIG. 1 is a diagram for explaining an outline of a movement transport system that causes a plurality of moving objects to cooperate with each other according to a first embodiment of the present invention.

FIG. 2 is a diagram illustrating an image of an inter-moving object connection hub that connects the moving objects according to the first embodiment of the present invention.

FIG. 3 is a diagram illustrating an overall outline of the movement transport system using a drone and a railway vehicle according to the first embodiment of the present invention.

FIG. 4 is a diagram illustrating an image of rights to use each facility of the movement transport system according to the first embodiment of the present invention.

FIG. 5 is a diagram illustrating an overall outline of a system that manages and controls operation of a drone that is a first moving object.

FIG. 6 is a flowchart illustrating a process procedure of a drone operation management system.

FIG. 7 is a diagram illustrating an image of calculation of a port occupancy probability that a single aircraft occupies a port.

FIG. 8 is a diagram illustrating an image in which port occupancy probabilities that a plurality of aircrafts occupy a port are aggregated.

FIG. 9 is a diagram illustrating an image of adjustment of the port occupancy probabilities.

FIG. 10 is a flowchart illustrating a process procedure for adjustment of port occupancy probabilities.

FIG. 11 is comprised of FIGS. 11A and 11B and is a flowchart illustrating a brief process procedure at a transporting phase in the movement transport system.

FIG. 12 is a diagram for explaining an outline of a movement transport system that causes a plurality of moving objects to cooperate with each other according to a second embodiment of the present invention.

### DESCRIPTION OF EMBODIMENTS

Hereinafter, embodiments of the present invention will be described with reference to the drawings.

The present invention is not limited to the following embodiments and includes various modification examples and application examples within the technical concept of the present invention.

### Embodiments

### First Embodiment

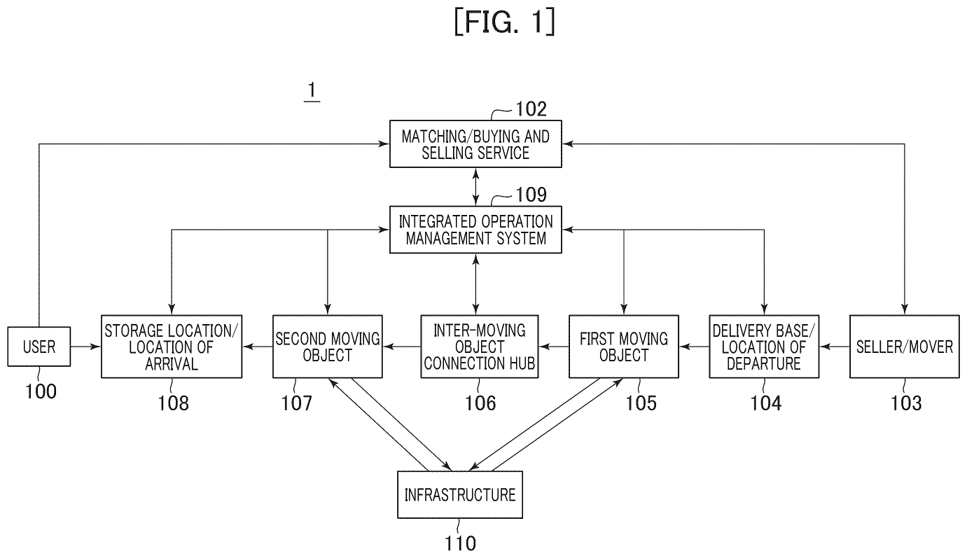

FIG. 1 is a schematic configuration diagram of a movement transport system (moving object operation management system) 1 that includes a moving object operation management device that causes a plurality of moving objects to cooperate with each other according to a first embodiment of the present invention.

FIG. 1 illustrates the movement transport system 1 that uses a plurality of moving objects (first moving object 105 and second moving object 107) to automatically transport a product after a user 100 purchases and pays for the product on sale and a transport fee on the Internet or the like.

In FIG. 1, first, the user 100 uses a matching/buying and selling service system 102 to select and purchase the product or the like, and a notification indicating an order for the product and permission for movement are notified to a seller/mover 103. The product or the like is an object 305 to be transported and is an article or a person. The object to be transported is moved to a delivery base/location of departure 104, and moved by the first moving object 105 to an inter-moving object connection hub 106 in the middle of on a route, and is reloaded or transferred to the second moving object 107 such as a railway vehicle 320, and then arrives at a location of arrival or a storage location 108 for the product.

The inter-moving object connection hub 106 includes a take-off and landing port 306 where the first moving object 105 such as a drone 300 takes off and lands.

The operation during movement from the delivery base/location of departure 104 to the location of arrival 108 is managed by an integrated operation management system 109. In a case where it is necessary to change a schedule or the like, the operation of each of the moving objects (first moving object 105 and second moving object 107) is adjusted. In addition, each of the moving objects (first moving object 105 and second moving object 107) receives information and supply of energy for movement from an infrastructure 110 as necessary.

As a specific example of the movement transport system 1, an example will be described in which distribution and transport are performed using a drone as the first moving object 105 and a railway vehicle as the second moving object 107. The second moving object 107 is not limited to a railway vehicle and may be a vehicle such as a car.

The drone has a high degree of freedom in where the drone can transport a package, and is often used to transport a small quantity of a package over a relatively short distance on demand.

Meanwhile, the railway vehicle is limited to locations where stations are present, but is often used to periodically transport a large quantity of a package over a long distance.

When a scenario in which these two moving objects are connected to transport a product or the like is considered, a mismatch occurs between the drone that has a small transport capacity and the railway vehicle that has an extremely large transport capacity. To solve such a problem, it is possible to take advantage of the strengths of the two moving objects and compensate for their weaknesses by operating a large number of drones such that the drones arrive in time for a regular train departure time.

An operation of the movement transport system 1 including the drone and the railway vehicle as an example will be described. The description here refers to the transport of products, but the same applies to the movement of people.

The movement transport system 1 mainly has an operation planning phase in which a route for movement and transport and a time for the movement and the transport are determined and reservations for each moving object and facility and the like are made, and a transporting phase in which things are actually loaded onto the moving objects such as the drone and the railway vehicle and moved.

First, the user 100 determines an order from among products registered in advance by the seller/mover 103 in the matching/buying and selling service system 102. In the matching/buying and selling service system 102, when the user 100 purchases a product, a request to deliver the product is transmitted to the seller/mover 103 and notified to the integrated operation management system 109.

Next, the integrated operation management system 109 coordinates and arranges operating times for transport of the product from the delivery base/location of departure 104 through the inter-moving object connection hub 106 to the storage location/location of arrival 108, and the moving objects to be used for transporting the product.

Next, operating times of other moving objects to be used at the delivery base/location of departure 104, the inter-moving object connection hub 106, and the storage location/location of arrival 108 in the same time zone as a time zone when the drone and the railway vehicle are used are adjusted and determined, and after that, settlement is completed in the matching/buying and selling service system 102.

Then, the operation planning phase is completed and the system proceeds to the transporting phase. However, an operation plan determined for transport to be performed once may be changed due to subsequent adjustments for other transport.

In the transporting phase, the seller/mover 103 transports the product to the delivery base/location of departure 104. This transport may be performed by the seller himself/herself, or may be performed using other means.

Next, the drone that is the first moving object 105 is used to transport the product from the delivery base/location of departure 104 to the inter-moving object connection hub 106 based on the determined route, the determined moving object, and the determined time.

Next, at the inter-moving object connection hub 106, the product is reloaded from the drone, which is the first moving object 105, to the railway vehicle, which is the second moving object 107.

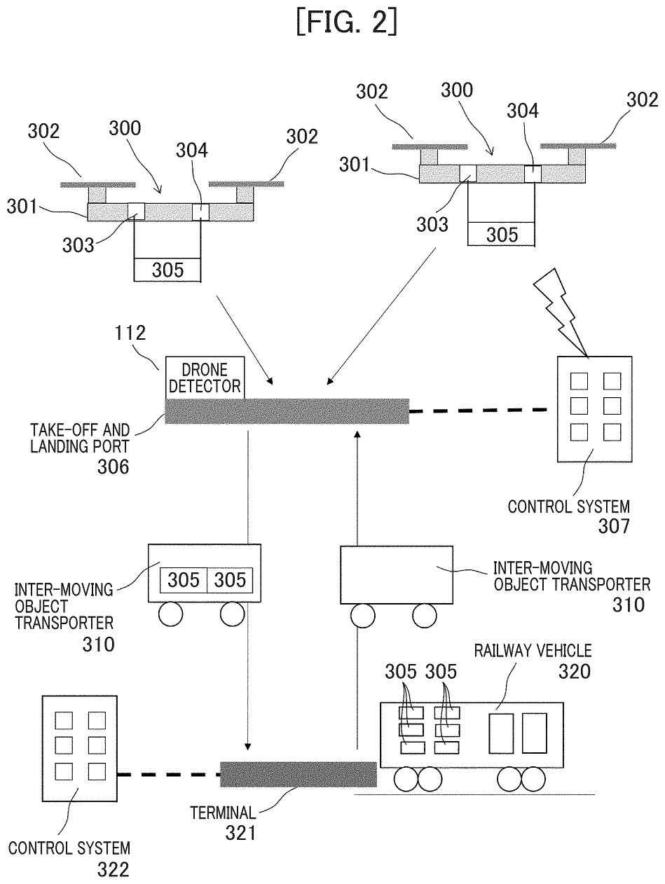

FIG. 2 illustrates an image in which a plurality of drones, which are first moving objects 105 that each carry a package, are connected to the railway vehicle, which is the second moving object 107. The connection of the drones, which are the first moving objects 105, and the railway vehicle, which is the second moving object 107, as illustrated in FIG. 2 is a specific example of the inter-moving object connection hub 106, but is not necessarily limited thereto. The system may be a system in which people and things contained in multiple types of moving objects are delivered by some means.

In FIG. 2, each of the drones 300 includes four blade rotors 302 provided at symmetrical positions on a rectangular housing body 301, and each of the blade rotors 302 is driven by an electric motor not illustrated. Each of the flying objects of the first embodiment is not limited thereto and may be a flying object that can take off and land in a vertical direction.

The housing body 301 is provided with a flying object control device 303 that includes a position and orientation sensor. The housing body 301 is also provided with a communication device 304 that communicates, with a drone control system 307, the position of the drone 300, which is a flying object, and a route through which the drone 300 passes. A known GNSS sensor and an inertial measurement device are provided to detect the position and orientation of the housing body 301.

In addition, the flying object control device 303 enables the drone 300 to fly along a planned flight route without colliding with other flying objects and obstacles by using, as altitude information of the planned flight route, values obtained by adding, to height reference values, flight altitudes corresponding to flight positions based on route information indicating the planned horizontal-plane flight route of the drone 300 that is a flying object, and the height reference values representing the elevations of ground surfaces below multiple positions on the planned flight route.

In addition, the object 305 to be transported is detachably attached to the housing body 301 outside or inside the housing body 301.

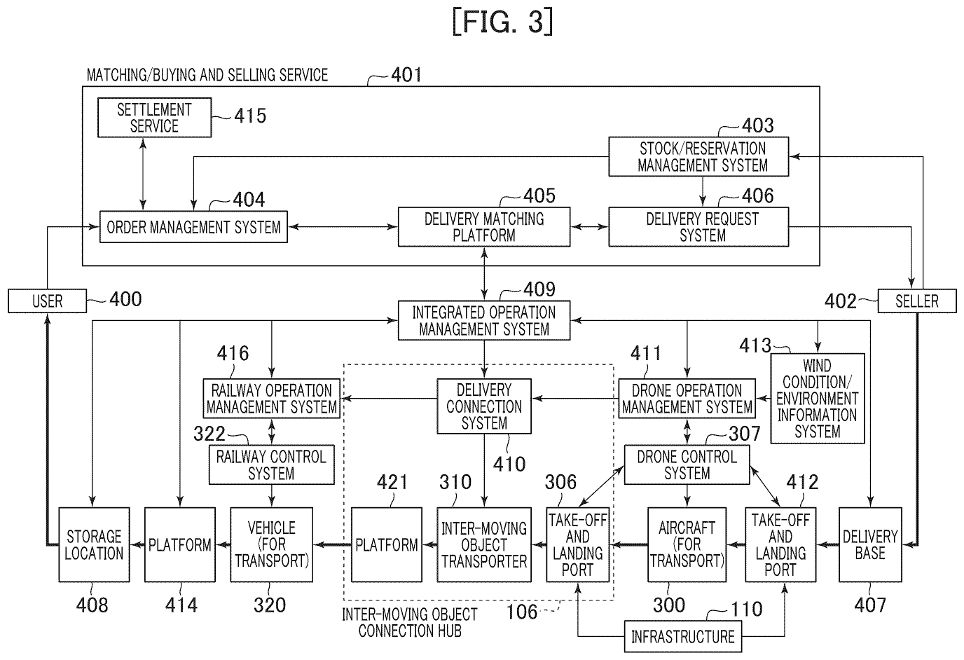

Meanwhile, the control system 307 that directs routes of the drones 300 that are flying objects is separated from the take-off and landing port 306 in FIG. 2, but may be integrated with the take-off and landing port 306. In addition, the single take-off and landing port 306 where a moving object such as a drone 300 takes off and lands is illustrated in FIG. 3, but a plurality of take-off and landing ports 306 may be provided.

However, it is assumed that the control system 307 directs a route of the drone 300 that is a flying object and approaches to at least one take-off and landing port 306 and that a plurality of routes are not directed for the drone 300, which is a flying object, by a plurality of control systems 307.

In a case where a plurality of drones 300 arrive at the take-off and landing port 306, a landing order is directed by the control system 307, the plurality of drones 300 land one by one, an object 305 to be transported is reloaded to a moving object transporter 310, a drone 300 takes off, and a drone 300 instructed to land next lands and repeats a similar operation.

The inter-moving object transporter 310 carrying the object 305 to be transported repeatedly moves, before a departure time, from the take-off and landing port 306 to a terminal 321 where the railway vehicle 320 stands by, loads the object 305 to be transported onto the railway vehicle 320, and moves back to the take-off and landing port 306.

The railway vehicle 320 arrives at the terminal 321 on time in accordance with an instruction of a railway control system 322 and waits until a departure time. During this time, the object 305 to be transported is loaded onto the railway vehicle 320 from the moving body transporter 310.

Next, the product is transported from the inter-moving object connection hub 106 to the storage location/location of arrival 108 by the railway vehicle 320 that is the second moving object 107. After the arrival, the product is stored and the arrival is notified to the user 100.

Lastly, when the user 100 who has received the notification indicating the arrival of the product receives the product at the storage location/location of arrival 108, the process performed by the movement transport system 1 on this product is ended.

Detailed operations of each system of the movement transport system 1 using the drone 300 and the railway vehicle 320 will be described using FIG. 3 illustrating the overall outline of the movement transport system 1 using the drone 300 and the railway vehicle 320, and a process procedure of each system. In addition, in FIG. 3, thick line arrows indicate the flow of a product, and thin lines indicate the flow of information.

First, to explain an operation at the operation planning phase, processes of a matching/buying and selling service 401 and an integrated operation management system 409 will be described.

First, a seller 402 registers, in a stock/reservation management system 403, the product, a delivery base 407 to which the product can be transported, a time when the product can be transported to the delivery base 407, and the like. The stock/reservation management system 403 cooperates with an order management system 404, and the registered information can be referenced in the order management system 404 to check stock and whether a reservation can be made.

In addition, an ID is assigned to the registered product, and registered in a delivery request system 406 together with the delivery base 407 to which the product can be transported, and the time when the product can be transported to the delivery base 407.

Next, the user 400 orders the product indicated by the stock/reservation management system 403 in the order management system 404.

Next, a location where the product will be held is checked in the order management system 404, and the location where the product will be held and details of the order are notified to a delivery matching platform 405.

From the location where the product will be held and the details of the order that have been acquired by the delivery matching platform 405, waypoints on a route from the delivery base 407 to the storage location 408 designated by the user 400 are searched and listed, and a maximum value of each required time is obtained and temporarily determined.

In this case, each required time includes at least a time for transport to the delivery base set by the seller 402, a time for the transport by each moving object, and a transport time necessary for reloading the product.

Next, the delivery matching platform 405 transmits the ID of the ordered product, a list of the waypoints on the route, and each required time to the integrated operation management system 409.

Based on the route and required time received by the integrated operation management system 409, applications are made to a drone operation management system (moving object operation management device) 411 for the right to use a take-off and landing port 412 on the take-off side and the take-off and landing port 306 on the landing side. The applications for the rights of use are made for the multiple types of moving objects in descending order of likelihood of observing a set time.

In the first embodiment, it is assumed that the probability that the drone observes the time is lower than the probability that the railway vehicle observes the time, and the applications for the rights of use are made to the drone operation management system (moving object operation management device) 411 in advance.

The above-described rights of use will be described. The rights of use are rights to use each of facilities including the take-off and landing ports (412, 306) and the aircraft, and are reservations for use of the facilities set on a time-by-time basis.

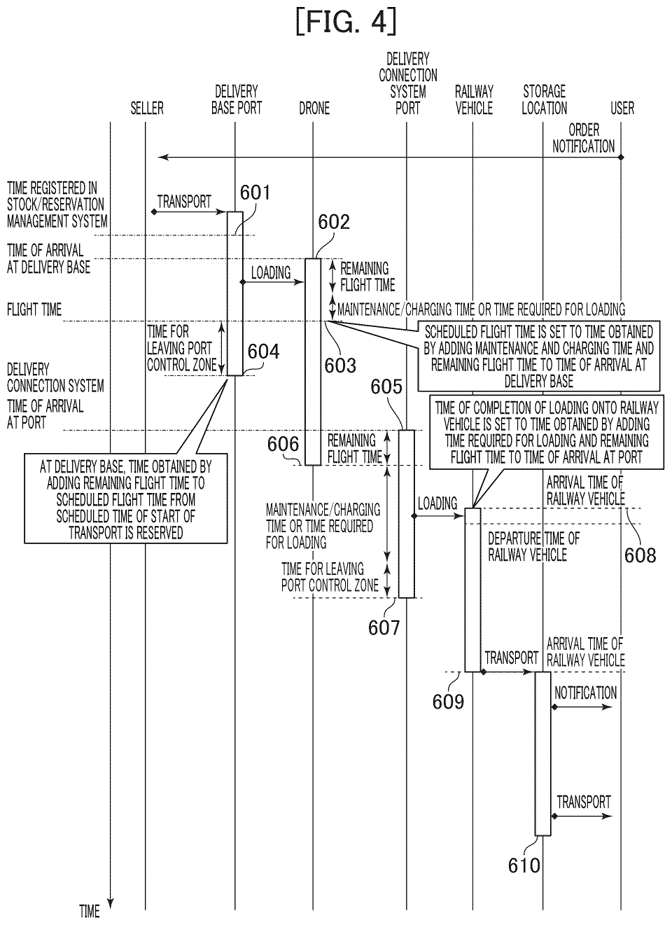

FIG. 4 illustrates the concept of the rights of use on a time axis. FIG. 4 illustrates the flow of time in a downward direction, and each of white frames indicates that the right to use each facility is set. In addition, the method for setting the rights of use described in the first embodiment is an example, and the setting method may be changed for each type of industry.

It is necessary to reserve and set the rights to use each facility so as to allow enough time for the actual use of the facility. The following exemplifies setting of the rights to use the take-off and landing port 412 on the delivery base side, the drone 300, and the port 306 on the delivery connection system 410 side.

The start time of the right to use the take-off and landing port 412 on the delivery base side is set to be earlier than a transportable time 601 registered in the stock/reservation management system 403 by the seller 402. In addition, in consideration of the possibility of a delay at a time 602 when the drone 300 is scheduled to arrive at the take-off and landing port 412 on the delivery base side, a scheduled flight time 603 is calculated by adding the longest time among a remaining flight time, which is the time during which the drone 300 can fly in the air, a time for maintenance and fuel charging, and a time required for loading, and a time 604, which is obtained by adding a time for leaving a port control zone to the scheduled flight time 603 is set as the right of use.

Regarding the time for leaving the port control zone, a predetermined airspace around the take-off and landing port 412 is set as the port control zone, and in the port control zone, only one aircraft is present at the same time. This is to avoid unexpected proximity and collision between multiple aircrafts when the aircrafts concurrently descend or take off.

In addition, the right to use the drone 300 is set from the time 602 when the drone 300 is scheduled to arrive at the take-off and landing port 412 on the delivery base side as a start time to a time 606 obtained by adding the remaining flight time to a time 605 of arrival at the take-off and landing port 306 on the delivery connection system 410 side.

Furthermore, the right to use the take-off and landing port 306 on the delivery connection system 410 side is set from the time 605 of the arrival at the take-off and landing port 306 on the delivery connection system 410 side as a start time to a certain time obtained by adding the time 606 obtained by adding the remaining flight time for flight on a route of the drone 300 to a longer time out of the time for maintenance and fuel charging and the time required for loading, or to a time 607 obtained by adding the time for leaving the port control zone to the above-described certain time in a case where the drone 300 takes off to go to a next target location.

In such a manner described above, the rights to use other facilities are set.

Next, based on the times applied for from the integrated operation management system 409, the drone operation management system (moving object operation management device) 411 determines, for the applied rights of use, times when the take-off and landing port 412 on the take-off side and the take-off and landing port 306 on the landing side are available, and an aircraft that can be operated for transporting the product, grants the rights of use for the transport of the product and notifies the integrated traffic management system 109 and the drone control system 307.

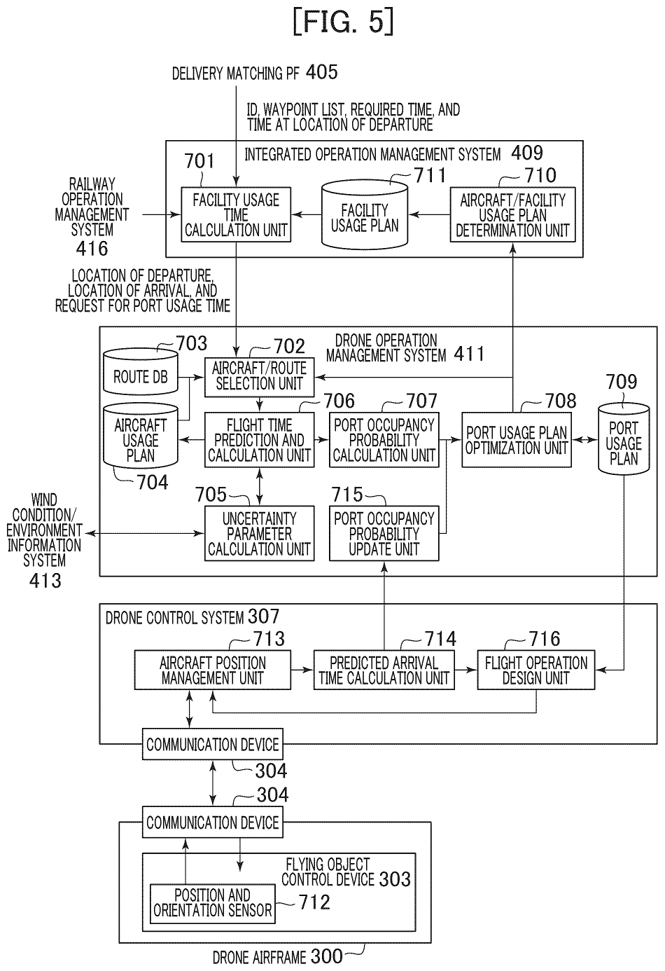

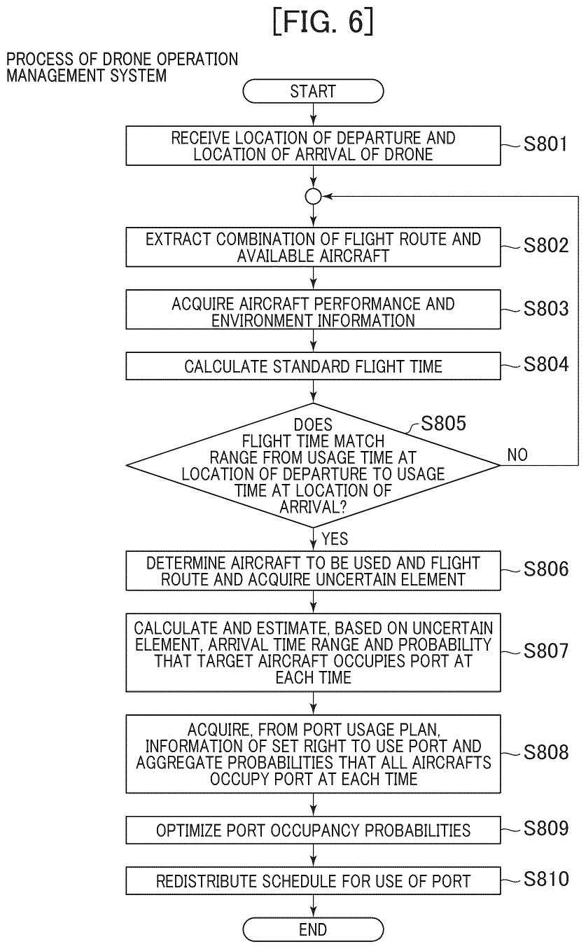

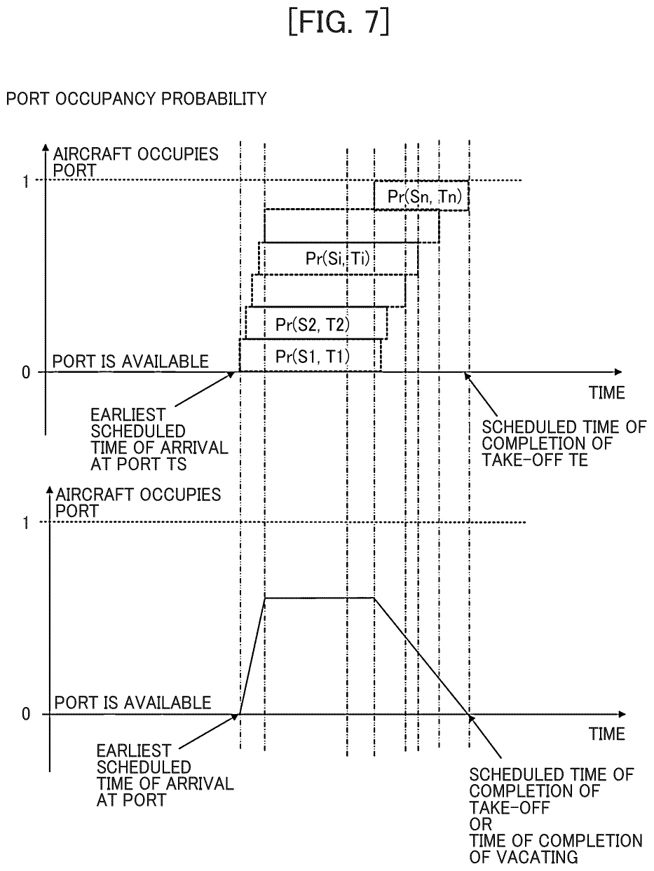

An operation of the drone operation management system (moving object operation management device) 411 will be described with reference to a system configuration illustrated in FIG. 5 and a process procedure illustrated in FIG. 6.

In step S801, usage times calculated by a facility usage time calculation unit 701 of the integrated operation management system 409 that are tentatively determined usage times of the take-off and landing port 412 on the delivery base side that is a location of departure of the drone 300 and the take-off and landing port 306 on the delivery connection system 410 side that is a location of arrival of the drone 300 are received.

Next, in step S802, an aircraft/route selection unit 702 determines a flight route based on the location of departure and the location of arrival acquired in S801 by using a route DB 703. In the route DB 703, a topological map in which waypoints indicating flight locations as shown by sequence of points is included and the route is set by using Dijkstra's algorithm or the like. It is assumed that, for a link connecting the waypoints, a standard speed at which an object flies in the section is defined.

In addition, an aircraft (drone 300) that is available for flight is selected using an aircraft usage plan 704 for the determined route. The aircraft usage plan 704 includes the right to use the aircraft at the corresponding time, a predicted flight distance at the corresponding time, the type of aircraft, wind resistance, and the degree of punctuality for billing or the like.

Next, in step S803, the aircraft performance of the drone 300 selected in step S802 is acquired from the aircraft usage plan 704, and an uncertainty parameter calculation unit 705 concurrently acquires wind condition/weather information from a wind condition/environment information system 413. The uncertainty parameter calculation unit 705 calculates and determines the probability of occurrence of a factor that affects an uncertain flight such as a wind condition or the like.

Next, in step S804, based on the flight route and the aircraft selected in step S802, and environment information such as the wind condition and the aircraft performance acquired in step S803, a standard flight time in a case where the aircraft selected flies on the flight route is calculated. The calculation of the flight time may vary due to a wind condition and other uncertain factors that affect the flight, but only information with the highest possibility is selected and used for the calculation of the flight time in step S804.

Next, in step S805, it is confirmed that the standard flight time calculated in step S804 falls within a range from the usage time at the location of departure to the usage time at the location of arrival acquired in step S801. The confirmation can be performed by using the following calculation.

(The end time of use at the location of arrival)−(the start time of use at the location of departure)>the standard flight time, and (the start time of use at the location of arrival)−(the end time of use at the location of departure)<the standard flight time.

In a case where the standard flight time does not fall within the range of the usage times, another route and/or another aircraft are/is selected and the processing from step S802 to S804 is repeated until the standard flight time falls within the range of the usage times.

Next, in step S806, the airframe of the drone 300 selected and the flight route are fixed and the uncertainty parameter calculation unit 705 acquires an uncertain element. Uncertainty in the movement time of the drone 300, which is a moving object, is calculated by calculating a range of fluctuation in the movement time from the type of the drone 300, which is a moving object, and the effect on the motion performance.

As an example of the uncertain element, a wind condition will be described. A wind vector is given in a certain region on the route. The wind vector is expressed by the magnitude of wind force and a wind direction. It is assumed that an error in the wind force and an error in the wind direction are given as variance values for this wind vector. In addition, as this uncertain element, the probability of the occurrence of the uncertain element may be directly given.

Next, in step S807, a port occupancy probability calculation unit 707 calculates a predicted arrival time using the uncertain element acquired in step S806, and calculates a range of the time. The predicted arrival time can be obtained by using the following Equation (1).

(The arrival time)=(the distance of the route/the standard speed)+(a delay caused by uncertainty)+(a departure time) . . . (1)

In the above-described Equation (1), the distance of the route and the standard speed are fixed values and are uniquely calculated. The delay caused by uncertainty is a delay time caused by each uncertainty element, and is treated as an event and as a probability, and is calculated according to an event that occurs in sections on the flight route.

For example, in the case of the wind condition, from the wind vector and motion performance of the aircraft in a certain section, the flight speed in the section is calculated. This speed is used to express the delay caused by uncertainty as a negative value in a case where it passes through the section at a time earlier than the time when it passes through the section at the original standard speed, and express the delay caused by uncertainty as a positive value in a case where it passes through the section at a time later than the time when it passes through the section at the original standard speed. The occurrence of uncertainty differs depending on the sections. Therefore, the final delay caused by uncertainty is calculated as the sum of delay times in the sections.

If the occurrence of uncertainty in each section can be divided into patterns, the number of layers of the final delay caused by uncertainty is equal to the number of combinations of the number of sections and the patterns of occurrence.

As a result of calculating the delay caused by uncertainty using a certain single set of patterns Si, the probability that the drone 300 arrives at a required arrival time T is the probability of occurrence of the patterns. The probability that the drone 300 arrives at the required arrival time T can be calculated by using the following Equation (2) as a simultaneous probability of each event as described below.

The probability Pr(Si, T) that the airframe of the drone 300 arrives at the time T=a probability Pr(N) that any trouble such as an aircraft trouble does not occur×a probability Pr(E) that the wind condition (first uncertainty) is correct×a probability Pr(M) that second uncertainty is correct×. . . ×a probability Pr(A) that adjustment occurs . . . (2)

If uncertainty is not present from the time when the airframe of the drone 300 arrives to the time when the airframe of the drone 300 takes off, the port is uniformly occupied at the same probability from the arrival at the port to the completion of the take-off. The probability that the take-off and landing port at the location of arrival is occupied by the drone 300 is calculated.

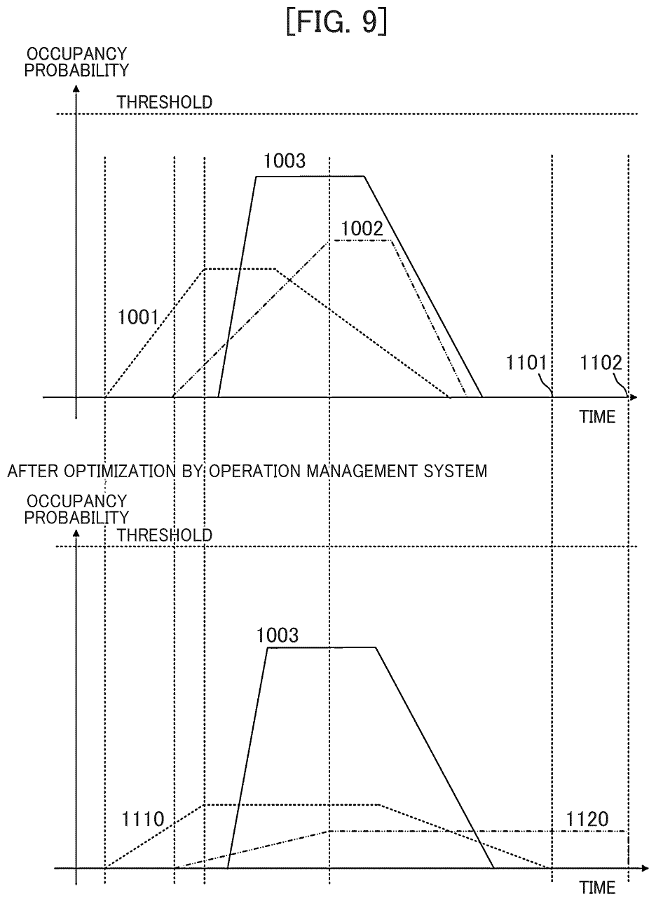

The occupancy probability is a probability that a target aircraft is present at (approaching (descending toward)) a target port at a target time. A probability distribution obtained by summing probabilities Pr (Si, T) of arrival at this port using all patterns is such a distribution as illustrated in FIG. 9, and can be expressed as a probability distribution function F(t) at the earliest scheduled time TS of arrival at the port and the latest scheduled time TE of completion of take-off.

In addition, a usage plan optimization unit 708 calculates the probability from arrival to take-off using the same concept as described above, even when there is uncertainty such as charging time due to remaining fuel and a remaining battery level in a time period between arrival at the port and completion of take-off. That is, the usage plan optimization unit 708 limits the time when the drone 300 that is a moving object uses the take-off and landing port 306 according to the remaining energy of the drone 300 that is a moving object, thereby increasing the probability that the moving object occupies the take-off and landing port 306, and allowing the take-off and landing port 306 to be used preferentially.

In addition, the usage plan optimization unit 708 can change the probability that the take-off and landing port 306 is occupied, depending on the remaining flight time of the drone 300, which is a flying object.

The probability function F(t) of the port occupancy probability by a drone n obtained as described above is recalculated so that the sum of all time zones in which this drone n may arrive is 1, and is treated as a probability function Fn(t).

In a case where the take-off and landing port itself is not available, all the time zones in which the drone n may arrive are not continuous and are separated by a time zone in which the take-off and landing port is not available. In this case, since the maximum range of time does not change, the probability that the port is occupied increases within a range in which the port is available. For example, the above-described case is a case where an intrusion detection sensor is installed at the take-off and landing port and an intrusion object is present on the port or a case where an aircraft is still present on the port even though the right to use it has expired due to emergency maintenance or the like.

The port occupancy probability calculation unit 707 calculates the port occupancy probability in a time zone excluding a time zone for emergency landing in a case where the drone 300 that is a flying object (moving object) that will make an emergency landing on the take-off and landing port 306 is approaching the take-off and landing port 306.

In addition, a drone detector (moving object detector) 112 that detects the drone 300 that is a flying object (moving object) that occupies the take-off and landing port 306 is disposed at the take-off and landing port 306, and the port occupancy probability calculation unit 707 calculates, based on a detection signal from the drone detector 112, the occupancy probability in a time zone excluding a time zone when the take-off and landing port 306 is occupied by the drone 300.

In addition, similarly, when an aircraft that needs to make an emergency landing occupies the port preferentially, this case can be handled in the same manner by locking a time zone in which the take-off and landing port is available.

Next, in step S808, the port usage plan optimization unit 708 aggregates, from the port usage plan 709, probabilities that the take-off and landing port for which the right of use has already been set and that is at the location of arrival is occupied.

In the port usage plan 709, a setting state of the right to use the target take-off and landing port at each time is stored.

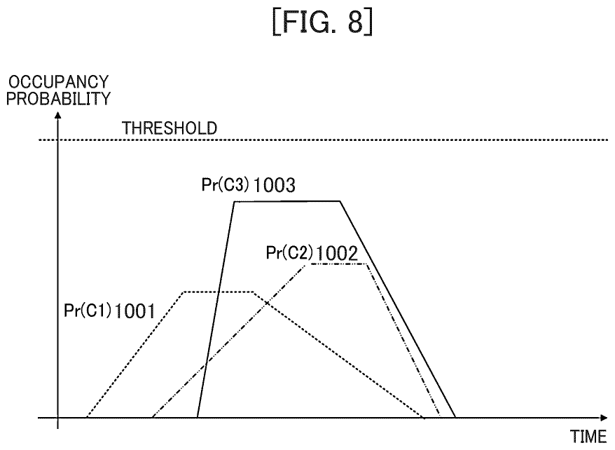

As the setting state of the right of use, time, an aircraft ID, an occupancy probability, and a maximum remaining flight time are set for each aircraft. The aggregated port occupancy probabilities are, for example, port occupancy probabilities as illustrated in FIG. 8.

In FIG. 8, a port occupancy probability Pr(C3) 1003 of an aircraft calculated in step S807 is superimposed on a port occupancy probability Pr(C1) 1001 of an aircraft C1 and a port occupancy probability Pr(C2) 1002 of an aircraft C2 for which the right of use stored in the port usage plan 709 has already been set.

It is assumed that each of the port occupancy probabilities does not reach a certain value and that a sum Pr(C) (=Σ²ₙ=₁Pr(Cn)) of the port occupancy probabilities 1001 and 1002 is equal to or less than the certain value. The certain value is treated as a threshold for the port occupancy probabilities. The threshold is set in order to take into consideration an unpredictable event in advance. For example, a bird and another flying object may obstruct the route of the drone 300, and the drone 300 may take a detour, or a disaster such as a fire may occur under the route and the drone 300 may be delayed by taking a detour. By giving these as probabilities in advance, it is possible to take into consideration an unpredictable event.

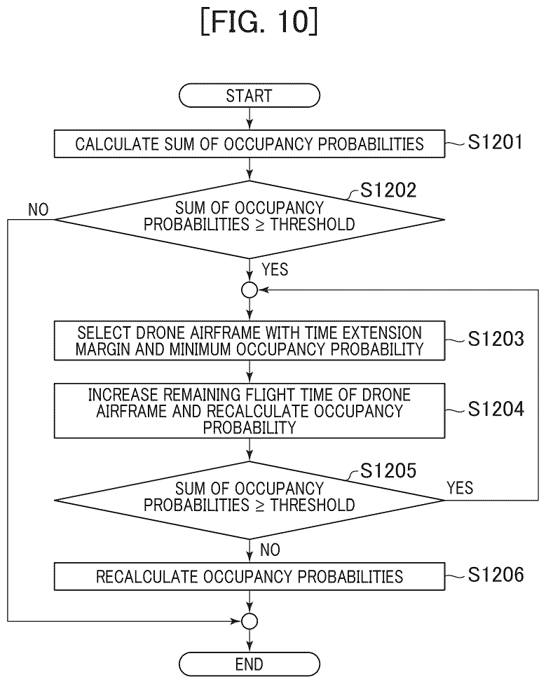

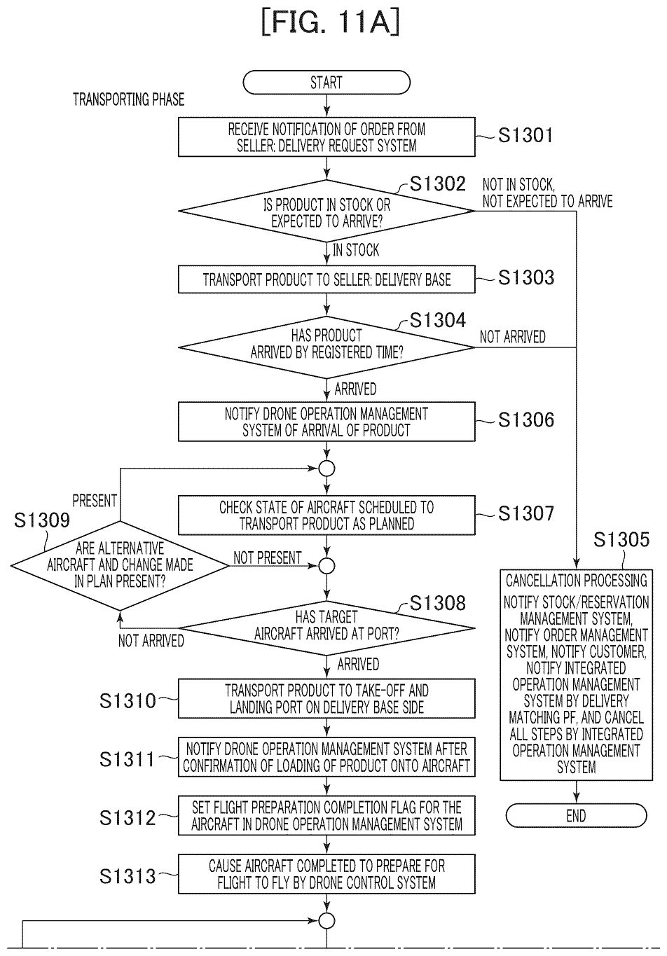

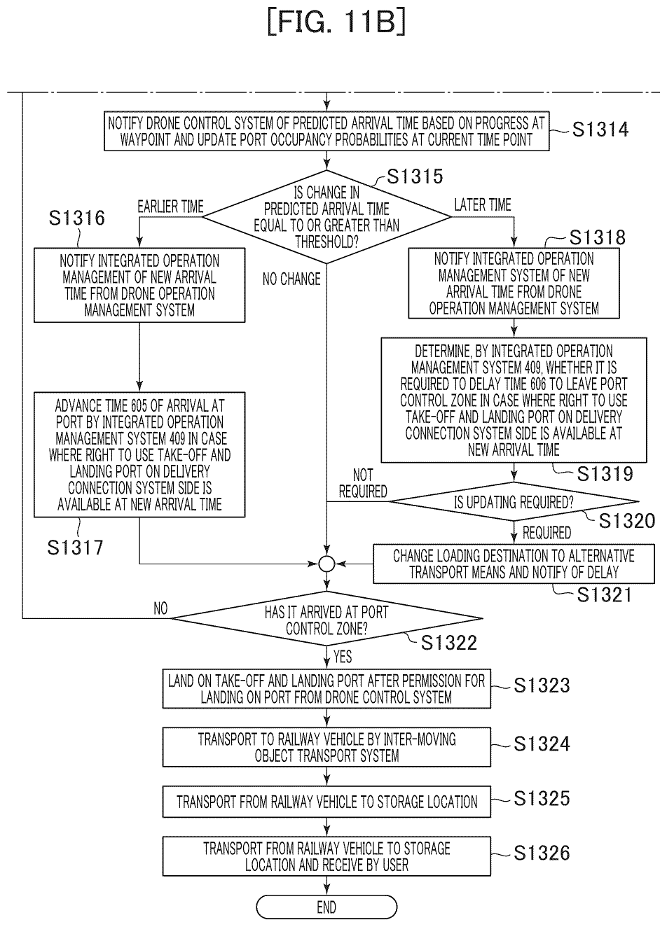

Next, in step S809, the port usage plan optimization unit 708 optimizes the port occupancy probabilities. The optimization of the port occupancy probabilities will be described with reference to a conceptual diagram illustrated in FIG. 11, which is comprised of FIGS. 11A and 11B, and a process procedure illustrated in FIG. 10.

In step S1201 illustrated in FIG. 10, the sum of the occupancy probabilities 1001 and 1002 of the aircrafts for which the rights of use stored in the port usage plan 709 have already been set, and the port occupancy probability 1003 calculated in step S807 is calculated.

In step S1202, the sum of the port occupancy probabilities calculated in step S1201 is compared with the threshold, and in a case where the sum of the port occupancy probabilities is less than the threshold, it is determined that the optimization is not required, and the process is ended. In addition, in a case where the sum of the port occupancy probabilities is equal to or greater than the threshold, the process proceeds to step S1203.

In step S1203, an airframe of a drone 300 with a minimum occupancy probability and a time extension margin is selected. In FIG. 9, a time extension margin 1101 for a drone 300 for which the right of use has been set and that occupies the port at the occupancy probability 1001 is compared with a time extension margin 1102 for a drone 300 for which the right of use has been set and that occupies the port at the occupancy probability 1002, and the occupancy probability 1002 that causes the longer time extension margin is selected.

In step S1204, the remaining flight time of the airframe of the drone 300 selected in step S1203 is increased by a defined time, and the occupancy probability is recalculated. Since the port occupancy probability is recalculated such that a sum of time zones is 1, the port occupancy probability decreases by the time by which the time zone is increased.

For example, in a case where the time zone for the port occupancy probability 1001 illustrated in FIG. 9 is increased to the remaining flight time 1101, the port occupancy probability 1001 illustrated in FIG. 9 decreases similar to a port occupancy probability 1110. Similarly, in a case the time zone for the port occupancy probability 1002 is increased to a time 1102, the port occupancy probability 1002 decreases similar to a port occupancy probability 1120.

Next, in step S1205, the sum of the occupancy probability of the selected aircraft recalculated in step S1204 and the occupancy probabilities calculated in step S1202 is compared with the threshold, and in a case where the sum of the occupancy probabilities including the occupancy probability of the selected aircraft recalculated in step S1204 is equal to or greater than the threshold, the processing from step S1203 to S1204 is repeated.

In step S1205, in a case where the sum of the occupancy probabilities including the occupancy probability of the selected aircraft recalculated in step S1204 is less than the threshold, the process proceeds to step S1206.

In step S1206, the occupancy probabilities are recalculated and the adjustment process is ended.

Next, in FIG. 6, in step S810, a setting for time when the right to use the port by the airframe of each drone 300 is updated in the port usage plan 709 according to the time of arrival at the port set in step S809, and is transmitted to an aircraft/facility usage plan determination unit 710 of the integrated operation management system 409, and a facility usage plan 711 is updated.

In addition, the time of arrival at the port set in step S809 is transmitted to the aircraft/route selection unit 702, and a flight time prediction and calculation unit (movement time prediction and calculation unit) 706 recalculates a take-off time based on a range of the time of arrival and updates the aircraft usage plan 704.

That is, the usage plan optimization unit 708 sets the take-off and landing port 306 to be allowed to be overlappingly used by a plurality of moving objects 105 based on the probabilities that the moving objects 105 occupy the take-off/arrival port 306, updates the occupancy probabilities at the time of the operation of the moving bodies 105, calculates the order of the occupancies, and determines the order in which the moving bodies 105 use the take-off and landing port 306.

Based on a result of the time adjustment for the right to use the take-off and landing port for the drone 300 notified to the integrated operation management system 409 through the above-described processing, an application is made for the right to use the railway vehicle at a departure time after the maximum delay time 606 (illustrated in FIG. 4) of the drone 300.

The railway operation management system (second moving object operation management device) 416 secures the right to use the railway vehicle 320 from a time 608 when the railway vehicle 320 arrives at a platform 421 on the delivery connection system side to a time 609 when the railway vehicle 320 arrives at a platform 414 on the storage location side after the time when an application is made from the integrated operation management system 409, and notifies a result of the securement to the integrated operation management system 409.

Next, the integrated operation management system 409 applies the right to use the storage location 408 in order to store the product from the time when the railway vehicle 320 arrives at the platform 414 on the storage location side, receives an available storage time 610 from the storage location 408, and notifies the delivery matching platform 405 of the available storage time 610.

Next, the delivery matching platform 405 notifies the order management system 404 of the confirmation of contents of an order and notifies the delivery request system 406 of details of delivery of the product.

Next, the delivery request system 406 notifies the seller 402 of a drone arrival time 602 which is a deadline for preparing the product with the corresponding ID at the delivery base 407.

As the last of the operation planning phase, the order management system 404 cooperates with the settlement service 415 to make a settlement for the customer.

Then, the operation planning phase ends and the process proceeds to the transporting phase.

At the transporting phase, the product is transported in order indicated by the thick line arrows in FIG. 3, and the time schedule will be implemented according to the rights to use each facility illustrated in FIG. 4, which have been planned in the flight planning phase. An operation of the system at the time of changing/updating the right of use will be described below, taking as an example the transport by the first moving object (drone 300) for which the right of use is sequentially changed due to many uncertain elements. A change in the right of use at the transporting phase will be described with reference to a process procedure illustrated in FIG. 11.

First, in step S1301, the seller 402 receives a notification of an order from the delivery request system 406.

Next, in step S1302, whether the product is in stock or expected to arrive is confirmed, and in a case where the product is not in stock, the process proceeds to step S1305 and cancellation processing is performed. In step S1302, in a case where the product is in stock, the process proceeds to step S1303.

In step S1303, the seller 402 transports the product to the delivery base 407.

Next, in step S1304, it is confirmed whether the product has arrived by a designated registered time. In a case where the product has not arrived, the process proceeds to step S1305 and the cancellation processing is performed. In step S1304, in a case where the product has arrived, the process proceeds to step S1306.

In step S1306, the arrival of the product to be transported is notified to the drone operation management system 411. In step S1307, the state of the airframe of the drone 300 scheduled to transport the product as planned in step S507 is checked.

In step S1308, in a case where the aircraft planned has arrived at the take-off and landing port 412 on the delivery base side, the process proceeds to step S1310. In step S1308, in a case where the aircraft planned has not arrived, in step S1309, it is confirmed whether an alternative aircraft and a change made in the facility usage plan 711 are present. In a case where the change made in the plan is present, the process returns to step S1307.

In step S1309, in a case where the change made in the plan is not present, it waits until the target aircraft arrives at the take-off and landing port 412 (step S1308).

Next, in step S1310, the product is transported to the take-off and landing port 412 on the delivery base side and loaded onto the drone 300.

In step S1311, after it is confirmed that the product is loaded onto the aircraft, the completion of preparation for take-off is notified to the drone operation management system 411. In step S1312, a flight preparation completion flag for the aircraft is set in the aircraft usage plan 704 of the drone operation management system 411.

Next, the drone control system 307 outputs a flight instruction to the drone 300 completely prepared for flying and causes the drone 300 to take off from the take-off and landing port 412. The flight after the take-off is performed in accordance with an instruction from the drone control system 307.

Next, in step S1314, a predicted arrival time is notified to the drone control system 307 based on the progress at a waypoint. The drone 300 flies after being instructed by the drone control system 307 to move to a target position (waypoint) at an operating speed. Output from the position and orientation sensor 712 incorporated in the flying object control device 303 installed in the drone 300 is notified to an aircraft position management unit 713 of the drone control system 307 by the communication device 304.

The aircraft position management unit 713 manages aircraft positions of all aircrafts in charge and transmits the acquired positions of the drones 300 to a predicted arrival time calculation unit 714, and the predicted arrival time calculation unit 714 calculates predicted arrival times. The predicted arrival times are calculated by dividing distances of remaining routes by the standard speed.

Furthermore, the calculated predicted arrival times are transmitted to a port occupancy probability update unit 715 of the drone operation management system 411, and port occupancy probabilities are calculated based on the acquisition of the positions of the drones 300 and the time of the acquisition. Updates of the port occupancy probabilities can be calculated in almost the same manner as step S807. A range of the predicted arrival times is calculated according to the following Equation (3) using uncertain elements on routes from the current positions to the take-off and landing port on the delivery connection system 411 side.

(A predicted arrival time)=(the distance of a remaining route/the standard speed)+(a delay caused by uncertainty on the remaining route)+(the time of acquisition of a position) . . . (3)

Since only the uncertainty on the remaining route from the time when the position of the drone 300 is acquired is considered, the range of the predicted arrival times is narrower than that in step S807. In addition, since the range is narrower, the kurtosis of the port occupancy probability increases, and certainty increases. The port usage plan optimization unit 708 aggregates, from the port usage plan 709, the calculated and updated port occupancy probabilities of airframes of other drones 300 in operation in a similar manner to step S808, optimizes the calculated port occupancy probabilities in a similar manner to step S809, and updates the port usage plan 709.

All kurtoses of port occupancy probabilities obtained from airframes of all drones 300 in operation are higher than those at the planning phase, there is less overlap with port occupancy probabilities of other aircrafts, and the port occupancy probabilities become so high that each of the port occupancy probabilities almost satisfies the threshold. Therefore, as the aircraft approaches the take-off and landing port 306, the occupancy probability is more independent. Safety is maintained by taking off and landing in the order determined in this case based on the landing, which will be described later.

Next, in step S1315, the port usage plan optimization unit 708 of the drone operation management system 411 updates the plan based on highly reliable information in a case where the predicted arrival time acquired in step S1314 has changed by a threshold or greater.

In a case where the predicted arrival time is almost the same as that at the planning phase or has not changed by the threshold or greater, the process proceeds to step S1322. In step S1315, in a case where the predicted arrival time has changed by the threshold or greater to an earlier time, the process proceeds to step S1316. In step S1315, in a case where the predicted arrival time has changed to a later time, the process proceeds to step S1318.

In step S1316, the port usage plan optimization unit 708 of the drone operation management system 411 notifies the new arrival time to the aircraft/facility usage plan determination unit 710 of the integrated operation management system 409.

In step S1317, in a case where the right to use the take-off and landing port on the delivery connection system 410 side is available at the new arrival time, the integrated operation management system 409 advances the time 605 of arrival at the port and the process proceeds to step S1322.

In a case where the predicted arrival time changes to the later time, the port usage plan optimization unit 708 of the drone operation management system 411 notifies the new arrival time to the aircraft/facility usage plan determination unit 710 of the integrated operation management system 409 in step S1318.

Next, in step S1319, in a case where the right to use the take-off and landing port on the delivery connection system 410 side is available at the new arrival time, the integrated operation management system 409 determines whether it is required to delay a time 606 to leave the port control zone, and the process proceeds to step S1320. This is a measure to be taken when a flight delay causes more energy to be consumed than expected and it takes time to charge a battery immediately before leaving the port control zone.

In step S1320, it is determined whether it is required to extend the right to use the port in step S1319. In a case where it is not required to extend the right to use the port, the process proceeds to step S1322. In a case where it is required to extend the right to use the port, there is a risk that it may not be possible to load onto the railway vehicle. Therefore, the user is notified of the necessity of changing the loading destination to alternative transport means, and the user 400 is notified of a delay in arrival of a package.

Next, in step S1322, it is determined whether the airframe of the drone 300 has arrived at the port control zone where the drone 300 prepares to land. In a case where the drone 300 has arrived at the port control zone, the process proceeds to step S1323. In a case where the drone 300 has not arrived at the port control zone, the process returns to the processing in step S1314.

In step S1323, the drone 300 lands on the take-off and landing port 306 after receiving permission for landing on the port from the drone control system 307. A flight operation design unit 716 of the drone control system 307 receives the predicted arrival time of the drone 300 from the predicted arrival time calculation unit 714, acquires the port usage plan 709 of the drone operation management system 411, sets permission for landing in order of priority of the drone 300 that will land and airframes of other drones 300 in the aircraft position management unit 713, and transmits a landing instruction from the aircraft position management unit 713 to the drone 300.

Next, in step S1324, after the drone 300 lands on the take-off and landing port 306, the moving object transporter 310 transports the product to the platform 421 in accordance with an instruction of the delivery connection system 410 and loads the product onto the railway vehicle 320 by a departure time.

Next, in step S1325, the railway vehicle 320 transports the product to the platform 414 where the target storage location 408 is located, in accordance with a safety instruction of the railway control system 322 and an operation instruction of the railway operation management system 416.

Lastly, in step S1326, the transport of the product is completed by transporting the product from the railway vehicle 320 to the storage location 408 and receiving the product by the user 400.

The main process procedure of the moving object transport system 1 is described above.

By performing the take-off and landing control described above, and allowing at least a plurality of flying objects to concurrently approach a single take-off and landing port from the planning phase, the take-off and landing port can be used safely and efficiently.

According to the first embodiment of the present invention, it is possible to provide the moving object operation management device, the moving object operation management system, and the moving object operation management method that allow safe and efficient take-off and landing during all time zones when the take-off and landing port 412 is available in a case where the plurality of drones 300 approach the single take-off and landing port 412.

### Second Embodiment

Next, a second embodiment of the present invention will be described.

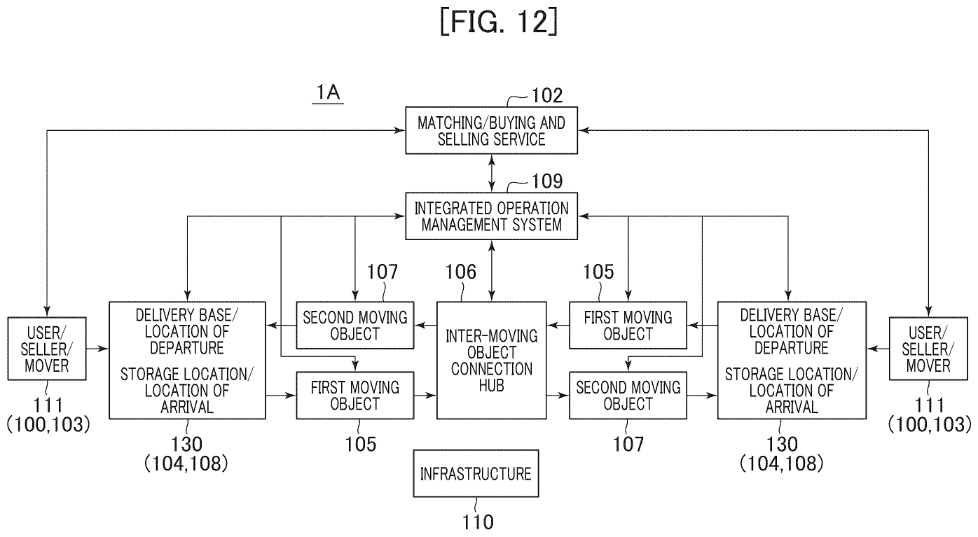

FIG. 12 is a schematic configuration diagram of a movement transport system (moving body operation management system) 1A that causes a plurality of moving objects to cooperate with each other according to the second embodiment.

In the moving object transport system 1 according to the first embodiment illustrated in FIG. 1, the delivery base/location of departure 104 and the storage location/location of arrival 108 are separated from each other. However, in the second embodiment illustrated in FIG. 12, delivery bases/storage locations 130 that serve as the delivery base/location of departure 104 and the storage location/location of arrival 108 are arranged at two points. That is, a product or the like can be delivered from two directions by using the first moving object 105 and the second moving object 107.

That is, the product or the like arrives at one of the delivery bases/storage locations 130 from the other of the delivery bases/storage locations 130 through the first moving object 105, the inter-moving object connection hub 106, and the second moving object 107.

The example illustrated in FIG. 1 and the example illustrated in FIG. 12 are different in whether or not the product or the like can be moved in both directions, but effects and operations are the same or similar. Therefore, description of the effects and operations in the example illustrated in FIG. 12 will be omitted.

In the second embodiment, similar effects to those obtained in the first embodiment can be obtained. In addition, the present invention can be applied to a moving object operation management system that can transport a product or the like in both directions from regions separate from each other.

The flying objects for transporting a package are unmanned, but development is underway with the aim of developing them into manned flying objects (so-called flying cars) in the future. Therefore, the present invention proposes a take-off and landing system that can be applied not only to an unmanned flying object but also to a manned flying object.

In addition, the flying objects are not limited to the multi-rotor type, but may be other autonomous flying objects.

The present invention is not limited to the above- described embodiments and includes various modification examples. For example, the embodiments have been described above in detail to explain the present invention in an easy-to-understand manner, and the embodiments are not necessarily limited to including all of the configurations described above. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

### LIST OF REFERENCE SIGNS

1, 1A: moving object transport system (moving object operation management system
100: user
102: matching/buying and selling service system
103: seller/mover
104: delivery base/location of departure
105: first moving object
106: inter-moving object connection hub
107: second moving object
108: storage location/location of arrival
109: integrated operation management system
110: infrastructure
111: user/seller
112: drone detector
130: delivery base/storage location
300: drone
301: housing body
302: rotor
303: flying object control device
304: communication device
305: object to be transported
306: take-off and landing port
307, 322: control system
310: inter-moving object transporter
320: railway vehicle
321: terminal
322: railway control system
400: user
401: matching/buying and selling service
402: seller
403: stock/reservation management system
404: order management system
405: delivery matching platform
406: delivery request system
407: delivery base
408: storage location
409: integrated operation management system
410: delivery connection system
411: drone operation management system
412: take-off and landing port
413: wind condition/environment information system
414, 421: platform
415: settlement service
416: railway operation management system (second moving object operation management device)
701: facility usage time calculation unit
702: aircraft/route selection unit
703: route DB
704: aircraft usage plan
705: uncertainty parameter calculation unit
706: flight time prediction and calculation unit
707: port occupancy probability calculation unit
708: port usage plan optimization unit
709: port usage plan
710: aircraft/facility usage plan determination unit
711: facility usage plan
712: position and orientation sensor
713: aircraft position management unit
714: predicted arrival time calculation unit
715: port occupancy probability update unit
716: flight operation design unit

1. A moving object operation management device that manages operation of a plurality of moving objects that carry an object to be transported, such as an article or a person, and move from a location of departure to a location of arrival, the moving object operation management device comprising:
a movement time prediction and calculation unit that calculates movement times of the moving objects;
an occupancy probability calculation unit that calculates, based on uncertainty in the movement times calculated based on information that affects the operation of each of the plurality of moving objects, a probability that the plurality of moving objects occupy a take-off and landing port where the moving objects take off and land; and
a usage plan optimization unit that makes a plan such that the take-off and landing port is occupied by the plurality of moving objects at all times.

2. The moving object operation management device according to claim 1,
wherein the usage plan optimization unit sets the take-off and landing port based on the probability that the plurality of moving objects occupies the take-off and landing port such that the plurality of moving objects are allowed to overlappingly use the take-off and landing port, calculates an order of the occupancy by updating the occupancy probability when the moving objects are in operation, and determines an order in which the plurality of moving objects use the take-off and landing port.

3. The moving object operation management device according to claim 1,
wherein uncertainty in the movement times is calculated by calculating a range of fluctuation in the movement times from a type of the moving objects and an effect on motion performance of the moving objects.

4. The moving object operation management device according to claim 1,
wherein the usage plan optimization unit increases the probability that the moving objects occupy the take-off and landing port, and causes the moving objects to preferentially use the take-off and landing port by limiting a time during which the moving objects use the take-off and landing port according to amounts of remaining energy of the moving objects.

5. The moving object operation management device according to claim 1,
wherein the moving objects are flying objects, and the usage plan optimization unit changes the occupancy probability of the take-off and landing port according to remaining flight times of the flying objects.

6. The moving object operation management device according to claim 1,
wherein the occupancy probability calculation unit calculates the port occupancy probability in a time zone excluding a time zone in which the moving objects make an emergency landing in a case where the moving objects that are to make an emergency landing at the take-off and landing port are approaching the take-off and landing port.

7. The moving object operation management device according to claim 6,
wherein the moving objects are flying objects, a moving object detector that detects the flying objects is disposed at the take-off and landing port, and the occupancy probability calculation unit calculates, based on a detection signal from the moving object detector, the occupancy probability in a time zone excluding a time zone in which the take-off and landing port is occupied by the flying objects.

8. The moving object operation management device according to claim 1,
wherein the plurality of moving objects include a first moving object that is a flying object, and a second moving object that moves the object that is to be transported and has been moved to a take-off and landing port where the first moving object takes off and lands to the storage location/location of arrival, and
the plurality of moving objects are used for a moving object operation management system including a second moving object operation management device that manages operation of the second moving object.

9. The moving object operation management device according to claim 8,
wherein the moving object operation management system includes an integrated operation management system that integrally manages operations of the first moving object and the second moving object.

10. A moving object operation management method for a moving object operation management device that manages operation of a plurality of moving objects that carry an object to be transported, such as an article or a person, and move along a specified route from a location of departure to a location of arrival, the moving object operation management method comprising:
calculating movement times of the moving objects;
calculating, based on uncertainty in the movement times calculated based on information that affects the operation of each of the plurality of moving objects, a probability that the plurality of moving objects occupy a take-off and landing port where the moving objects take off and land; and
making a plan such that the take-off and landing port is occupied by the plurality of moving objects at all times.

11. The moving object operation management method according to claim 10, further comprising:
setting the take-off and landing port based on the probability that the moving objects occupy the take-off and landing port such that the plurality of moving objects are allowed to overlappingly use the take-off and landing port, calculating an order of the occupancy by updating the occupancy probability when the moving objects are in operation, and determining an order in which the plurality of moving objects use the take-off and landing port.

12. The moving object operation management method according to claim 10,
wherein uncertainty in the movement times is calculated by calculating a range of fluctuation in the movement times from a type of the moving objects and an effect on motion performance of the moving objects.

13. The moving object operation management method according to claim 10, further comprising:
increasing the probability that the moving objects occupy the take-off and landing port, and causing the moving objects to preferentially use the take-off and landing port by limiting a time during which the moving objects use the take-off and landing port according to amounts of remaining energy of the moving objects.

14. The moving object operation management method according to claim 10,
wherein the moving objects are flying objects, and the occupancy probability of the take-off and landing port is changed according to remaining flight times of the flying objects.

15. The moving object operation management method according to claim 10,
wherein calculating the port occupancy probability in a time zone excluding a time zone in which the moving objects make an emergency landing in a case where the moving objects that are to make an emergency landing at the take-off and landing port are approaching the take-off and landing port.
